(19) United States
(12) Patent Application Publication
(10) Pub. No.: US 2024/0306049 A1
(43) Pub. Date: Sep. 12, 2024

(54) METHOD AND APPARATUS FOR PERFORMING PSCELL CHANGE PROCEDURE

(71) Applicant: LENOVO (BEIJING) LIMITED, Beijing (CN)

(72) Inventors: Le Yan, Shanghai (CN); Mingzeng Dai, Shanghai (CN); Congchi Zhang, Shanghai (CN); Haiming Wang, Beijing (CN)

(21) Appl. No.: 18/261,432

(22) PCT Filed: Jan. 14, 2021
(86) PCT No.: PCT/CN2021/071847

§ 371 Date: Jul. 13, 2023

(51) Int. Cl. H04W 36/00; H04W 24/02; H04W 36/08; H04W 36/30

(52) U.S. Cl. CPC H04W 36/0069; H04W 24/02; H04W 36/08; H04W 36/30

(57) ABSTRACT

The present application relates to a method and an apparatus for performing a Primary Secondary Cell (PSCell) change procedure. One embodiment of the present disclosure provides a method, which includes: receiving first information associated with a user equipment (UE) for a secondary node (SN) change or a primary secondary cell (PSCell) change; and/or receiving second information associated with one or more candidate nodes for the SN change or the PSCell change; and determining an action regarding the SN change or the PSCell change with a machine learning (ML) model based on the first information and/or the second information.

### TECHNICAL FIELD

The present disclosure relates to wireless communication technologies, especially to a method and an apparatus for performing a Primary Secondary Cell (PSCell) change procedure.

### BACKGROUND OF THE INVENTION

With the development of machine learning (ML) technology, for example, artificial intelligence (AI) technology, it might be used in radio access network (RAN), to further optimize the performance of communication systems. For example, the ML technology might be used for energy saving, load balancing, traffic steering, or mobility optimization, etc.

Therefore, it is desirable to provide methods and apparatuses for performing the PSCell change procedure using the AI/ML technology.

### SUMMARY

One embodiment of the present disclosure provides a method, which includes: receiving first information associated with a user equipment (UE) for a secondary node (SN) change or a primary secondary cell (PSCell) change; and/or receiving second information associated with one or more candidate nodes for the SN change or the PSCell change; and determining an action regarding the SN change or the PSCell change with a machine learning (ML) model based on the first information and/or the second information.

In one embodiment of the present disclosure, the method further includes: triggering the SN change or the PSCell change based on a determined action.

In one embodiment of the present disclosure, the first information is received from the UE directly and/or from a master node, and includes at least one of the following information: one or more measurement results of one or more candidate cells managed by the one or more candidate nodes; mobility history information; predicted quality of service (QoS), or traffic parameters of the one or more candidate nodes; QoS or traffic parameters of the one or more candidate nodes in a past time period; a predicted cell load of each of the one or more candidate cells; a cell load of each of the one or more candidate cells in a past time period; a predicted SN change frequency or a predicted PSCell change frequency; a SN change frequency or a PSCell change frequency in a past time period; and a predicted probability of accessing to the one or more candidate cells.

In one embodiment of the present disclosure, the second information is received from the one or more candidate nodes and/or from a master node and/or from the source SN, or determined by a source secondary node, and wherein the second information includes at least one of the following information in the one or more candidate nodes or in one or more candidate cells managed by the one or more candidate nodes: a number of active UEs in a past time period; resource utilization in the past time period; a capacity in the past time period; QoS or traffic parameters in the past time period; RRC connections in the past time period; a cell load in the past time period; SN change frequency in the past time period; a predicted number of active UEs; predicted resource utilization; a predicted capacity; predicted QoS or predicted traffic parameters; predicted RRC connections; a predicted cell load; predicted SN change frequency; and a predicted probability of being accessed by the UE.

In one embodiment of the present disclosure, the action includes at least one of the following information: a determination for whether performing a SN change or a PSCell change or not; a determination of a time for performing the SN change or the PSCell change; a determination for performing an inter-SN PSCell change or an intra-SN PSCell change; a determination of a target node for the SN change; a determination of a target PSCell for the PSCell change; a determination of SN change or inter-SN PSCell change parameters; a determination of PSCell change or intra-SN PSCell change parameters; and a determination for activating or deactivating a target secondary cell group corresponding to a target SN.

In one embodiment of the present disclosure, the method further includes: receiving a first feedback from the UE directly or indirectly, wherein the first feedback includes at least one of the following information: a time period from a time point when the UE accessed to the target SN or the target PSCell to a time point when the UE is out of a coverage of the target SN or the target PSCell; QoS level latency, a QoS level packet loss rate, or a QoS level jitter in a target SN or a target PSCell; one or more traffic patterns of the UE in the target SN or the target PSCell; resource utilization of the UE in the target SN or the target PSCell; one or more service requirements of the UE; and one or more connectivity configurations of the UE.

In one embodiment of the present disclosure, the method further includes: receiving a second feedback from a target SN and/or from a master node, or determining the second feedback, wherein the second feedback includes at least one of the following information: a time period from a time point when the UE accessed to the target SN or the target PSCell to a time point that when UE is out of a coverage of the target SN or the target PSCell; QoS level latency, a QoS level packet loss rate, or a QoS level jitter associated with the target SN or the target PSCell; radio efficiency associated with the target SN or the target PSCell; mobility history information associated with the target SN or the target PSCell; and one or more connectivity configurations applied by the target SN or the target PSCell.

In one embodiment of the present disclosure, the method further includes retraining the ML model based on the first feedback and/or the second feedback and/or a determined action; and updating the ML model.

In one embodiment of the present disclosure, the method further includes at least transmitting the first feedback, or the second feedback, or a determined action, to a host which provides the ML model, for retraining the ML model.

In one embodiment of the present disclosure, the method further includes receiving an updated ML model.

In one embodiment of the present disclosure, the method further includes transmitting a first request to a master node or to the UE for the first information; and/or transmitting a second request to a master node or to the one or more candidate nodes for the second information.

In one embodiment of the present disclosure, the one or more candidate nodes are determined based on the first information.

In one embodiment of the present disclosure, the first request and the second request are transmitted in one message or transmitted in two different messages.

In one embodiment of the present disclosure, the method further includes: at least transmitting a third request to the UE, or a master node (MN), or a target SN, for the first feedback; and/or at least transmitting a fourth request to the MN or the target SN for the second feedback.

In one embodiment of the present disclosure, the third request and the fourth request are transmitted in one message or transmitted in two different messages.

In one embodiment of the present disclosure, the method further includes: transmitting a fifth request for the ML model to a host which trains the ML model for SN change or PSCell change.

In one embodiment of the present disclosure, the method further includes: applying the ML model associated with the SN change or the PSCell change of the UE.

Yet another embodiment of the present disclosure provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement a method, which includes: applying a machine learning (ML) model associated with a secondary node (SN) change or a primary secondary cell (PSCell) change of a user equipment (UE); receiving first information associated with the UE for the SN change or the PSCell change; receiving second information associated with one or more candidate nodes for the SN change or the PSCell change, and/or determining second information for the SN change or the PSCell change; and determining an action regarding the SN change or the PSCell change with the ML model based on the first information and/or the second information.

### BRIEF DESCRIPTION OF THE DRAWINGS

FIG. 1 illustrates a functional framework for RAN intelligence according to some embodiments of the present disclosure.

FIG. 2 illustrates a flow chart of SN change initiated by the MN according to some embodiments of the present disclosure.

FIG. 3 illustrates a flow chart of SN change initiated by the SN according to some embodiments of the present disclosure.

FIG. 4 illustrates a flow chart of SN change or PSCell change initiated by the MN using the ML technology according to some embodiments of the present disclosure.

FIG. 5 illustrates a flow chart of SN change or PSCell change initiated by the SN using the ML technology according to some embodiments of the present disclosure.

FIG. 6 illustrates a method performed by a node for performing a SN change procedure according to a preferred embodiment of the present disclosure.

FIG. 7 illustrates a block diagram of an apparatus for performing a SN change procedure according to the embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

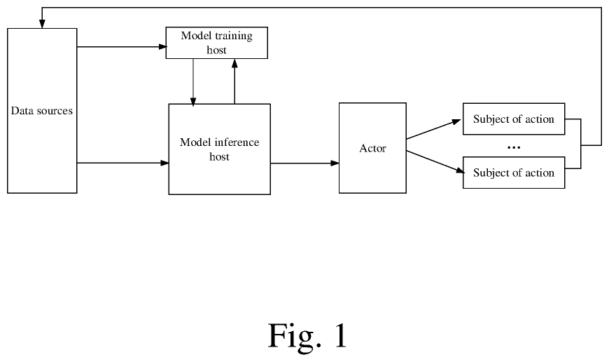

FIG. 1 illustrates a functional framework for RAN intelligence in accordance with some embodiments of the present disclosure.

FIG. 1 includes the following components:
a) Data sources, which may collect data from the network nodes, management entity or UE or OAM or core network, and provide training data to the model training host, and provide inference data to the model inference host. The data sources also receive model performance feedback from the actor or at least one subject of action.
b) Model training host, which may train the ML model based on the training data received from the data sources, and may provide ML model or the updated ML model to the model inference host. The ML model may be a data driven algorithm by applying machine learning techniques that generates a set of outputs consisting of predicted information, based on a set of inputs. Optionally, the model training host can receive model performance feedback from the actor or at least one subject of action. The model training host may also receive model performance feedback from the model inference host. The model training host may use an online or offline process to train an ML model by learning feature and patterns that best present data (e.g. training data) and get the trained ML model for inference.
c) Model inference host, which may receive the inference data from the data sources, based on the inference data and the ML model, the model inference host transmits an output to the actor. The model inference host may also transmit model performance feedback to the model training host. The Model inference host may perform a process of using a trained ML model to make a prediction or guidance or policy, or determine at least one action based on collected data (e.g. inference data) and ML model.
d) Actor, which determines/executes one or more actions based on the output of the model inference host, and informs the determination or action guidance to at least one subject of action.
e) Subject of action, which follows the instructions from the actor, and may transmit performance feedback to the data sources after action is performed.

The functional framework for RAN intelligence in FIG. 1 may perform the different types of machine learning processes such as supervised learning, unsupervised learning, reinforcement learning (RL), or the like.

In supervised learning, the training data includes the input data with a known label or desired output. Supervised learning algorithms learn a general rule that maps inputs and outputs. Common algorithms include support vector (SVM), K-nearest neighborhood (KNN), linear regression and etc. Most of deep learning approach is also based on the supervised learning, e.g. convolutional neural network (CNN), recurrent neural network (RNN), long short-term memory (LSTM), and etc.

In unsupervised learning: the training data only includes the input data so unsupervised learning algorithms find the structure from unlabeled input data, like clustering. Common algorithms include K-means clustering, principal component analysis (PCA) and etc.

The RL is based on alternative interaction between agent and environment. The agent performs certain action and the state will change which leads to the reward or a penalty. RL performs a certain goal with multiple interactions with the dynamic environment. Common algorithms include Q-learning, Deep RL, and etc.

In New Radio (NR) system, the targets of communication systems are expanded to joint optimization of increasing numbers of key performance indicators (KPIs) including latency, reliability, use experience, etc. However, NR brings new problems that are hard to be modelled, solved and implemented through the current conventional framework. The present disclosure proposes to use the machine learning technology to further improve the performance of the wireless network.

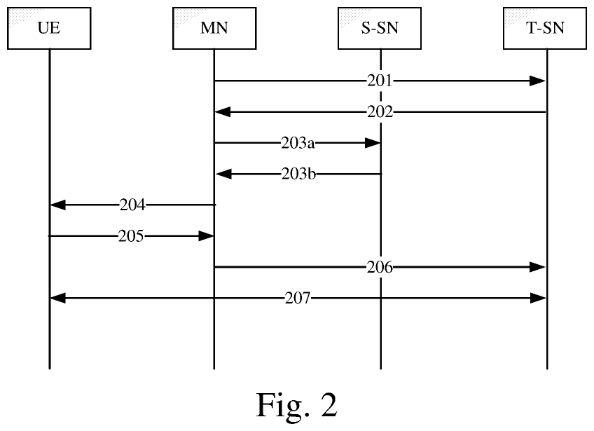

FIG. 2 illustrates a flow chart of SN change initiated by the MN according to some embodiments of the present disclosure.

FIG. 2 includes four different components, UE refers to a user equipment (UE), MN refers to a master node (MN), S—SN refers to a source secondary node (SN), and T-SN refers to a target SN. The MN can be an eNB that connected to evolved packet core (EPC) or 5G core network (5GC), or it can be a gNB. The source SN can be an eNB that connected to EPC or 5GC, or it can be a gNB.

In step 201, the MN initiates the SN change by transmitting a SN addition request to the target SN, which requests the target SN to allocate resources for the UE by means of the SN Addition procedure. The MN may include measurement results related to the target SN.

In step 202, the target SN transmits an acknowledge (ACK) to the SN addition request to the MN. If data forwarding is needed, the target SN provides data forwarding addresses to the MN. The target SN includes the indication of the full or delta RRC configuration.

If the allocation of target SN resources is successful, in step 203a, the MN transmits a SN Release request to the source SN, to release the source SN resources, which also includes a cause indicating secondary cell group (SCG) mobility. In step 203b, the source SN transmits an ACK to the SN Release request. The reception of the SN release request message triggers the source SN to stop providing user data to the UE.

In step 204, the MN transmits a message to the UE, which triggers the UE to apply the new configuration. The MN indicates the new configuration to the UE in the MN RRC reconfiguration message including the target SN RRC reconfiguration message. If MN is an eNB that is connected to EPC or 5GC, the message may be a RRC Connection reconfiguration message. If MN is a gNB, the message may be a RRC reconfiguration message.

The UE applies the new configuration, and in step 205, the UE sends the MN RRC reconfiguration complete message, including the SN RRC response message for the target SN, if needed.

In step 206, if the RRC (connection) reconfiguration procedure is successful, the MN informs the target SN via SN reconfiguration complete message with the included SNRRC response message for the target SN, if received from the UE.

In step 207, the UE synchronizes to the target SN.

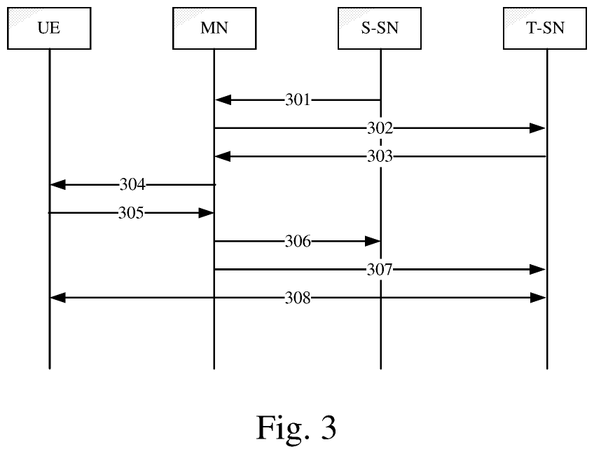

FIG. 3 illustrates a flow chart of SN change initiated by the SN according to some embodiments of the present disclosure.

In step 301, the source SN initiates the SN change procedure by sending the SN change required message to the MN, which contains a candidate target node ID, i.e., the ID of the target SN, and may include the SCG configuration, to support delta configuration, and measurement results related to the target SN.

In step 302, the MN requests the target SN to allocate resources for the UE by transmitting a SN addition request to the target SN, which includes the measurement results related to the target SN received from the source SN. In step 303, the target SN transmits an ACK to the SN addition request to the MN. If data forwarding is needed, the target SN provides data forwarding addresses to the MN. The target SN includes the indication of the full or delta RRC configuration.

In step 304, the MN transmits a message to the UE, which triggers the UE to apply the new configuration. The MN indicates the new configuration to the UE in the MN RRC reconfiguration message including SN RRC reconfiguration message generated by the target SN. If MN is an eNB that is connected to EPC or 5GC, the message may be a RRC Connection reconfiguration message. If MN is a gNB, the message may be a RRC reconfiguration message. The UE applies the new configuration, and in step 305, the UE sends the MN RRC reconfiguration complete message, including the SNRRC response message for the target SN, if needed.

If the allocation of target SN resources is successful, in step 306, the MN confirms the change of the source SN. If data forwarding is needed the MN provides data forwarding addresses to the source SN. If direct data forwarding is used for SN terminated bearers, the MN provides data forwarding addresses as received from the target SN to source SN. Reception of the SN Change Confirm message triggers the source SN to stop providing user data to the UE and, if applicable, to start data forwarding.

In step 307, if the RRC (connection) reconfiguration procedure is successful, the MN informs the target SN via SN Reconfiguration Complete message with the included SNRRC response message for the target SN, if received from the UE.

In step 308, the UE performs a RACH process, to synchronize to the target SN.

The methods in FIGS. 2 and 3 are not performed using the AI technology, and the efficiency and performance of the SN change procedure and the PSCell change procedure are relatively low.

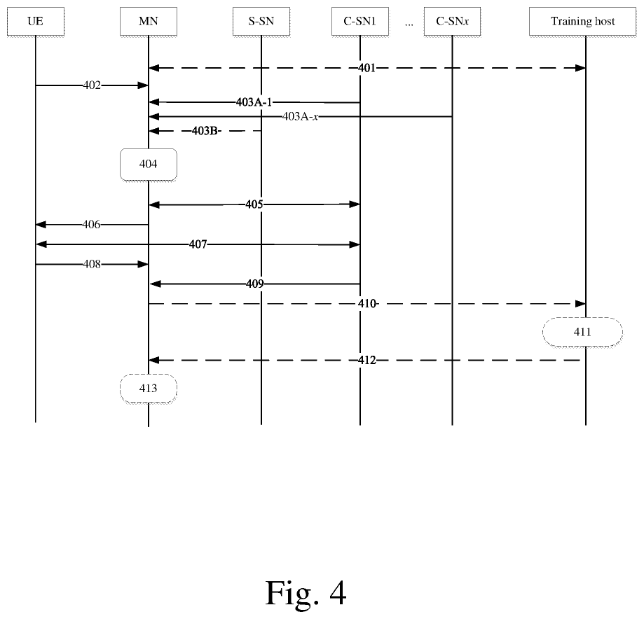

FIG. 4 illustrates a flow chart of SN change or PSCell change initiated by the MN using the AI technology according to some embodiments of the present disclosure.

FIG. 4 includes at least 6 components, the UE, the MN, the source SN (S—SN), the candidate SN1 (C-SN1), . . . , the candidate SNx (C-SNx), and the training host, wherein x is an integer equal to or larger than one. Each candidate SN may manage one or more cells, and the cell that is accessed by the UE is considered as the target PSCell of the UE, the target PSCell may be one cell managed by the source SN or one candidate SN.

In step 401, the MN determines the ML model to be applied. If the MN is capable of training the ML model, then the MN may determine the ML model by itself or deploy the ML model trained by the MN itself. If the MN is not capable of training the ML model, it may obtain the ML model from other nodes. For example, in FIG. 4, the ML model is received from the training host, for example, the operation, administration and maintenance (OAM), the ML model may be received from other nodes, such as: a S—SN, a UE, or any source that is capable of providing the ML model to the MN.

In step 402, the MN obtains the first information relating to the SN change or the PSCell change from the UE. In steps 403A-1, . . . , 403A-x, the MN obtains the second information relating to the SN change or the PSCell change from one or more candidate SNs, i.e. C-SN1, . . . , C-SNx. The candidate SNs may be neighbor nodes of the MN, which has a potential of serving the UE after the SN change procedure.

In some embodiments, the MN may determine the candidate SNs based on the first information, for example, the MN may determine the candidate SNs based on the measurement results, velocity, and/or cell load information received from the UE.

Besides the candidate SNs, the MN may also obtain the second information from the source SN, and the second information includes the information in the one or more cells (including candidate cells and/or the serving SCG before SN change/PSCell change) managed by the source SN.

In some embodiments, the first information or the second information may be referred to as the traffic steering related augmented information and/or statistical information from the UE and/or the candidate SNs and/or the S—SN. The first information and/or the second information can be treated as inference data for prediction or guidance, or determining at least one action.

Hereinafter in the present disclosure, the first information refers to the traffic steering related augmented information, the statistical information, or any information relating to the SN change or the PSCell change determined by the UE; similarly, the second information refers to the traffic steering related augmented information, the statistical information, or any information relating to the SN change or the PSCell change determined by the one or more candidate SNs or the S—SN.

The first information may include any of the following information:
a) measurement results of one or more candidate cells managed by the one or more candidate nodes, i.e., the reference signal receiving power (RSRP), the reference signal receiving quality (RSRQ), the signal to interference plus noise ratio (SINR), the channel quality information (CQI) of one or more cells in the one or more candidate SNs; for example, the RSRP determined by the UE in a cell managed by C-SN1; measurement results of one or more cells (e.g. source SCG) managed by the S—SN, and measurement results of one or more cells managed by the MN (e.g. source MCG).
b) trajectory information of the UE;
c) Quality of service (QoS), or traffic parameters of the one or more neighbor nodes, i.e., per QoS level latency, the latency may include: end to end (E2E) latency, round trip time (RTT), L2-latency, or the like; per QoS level packet loss rate, per QoS level jitter; and quality of service (QoS) or traffic parameters of one or more cells (e.g. source SCG) managed by the S—SN, quality of service (QoS) or traffic parameters of one or more cells managed by the MN (e.g. source MCG).
d) cell load of at least one cell managed by the one or more the candidate SNs, cell load of one or more cells (e.g. source SCG) managed by the S—SN, and cell load of one or more cells managed by the MN
e) SN change frequency or PSCell change frequency;
f) the speed, velocity, moving direction, rotation, and/or the altitude of the UE;
g) mobility history information, for example, it might be information for a number of cells visited by the UE, which may be indicated by an information element (IE) named: Last Visited NG-RAN Cell Information; and
h) a predicted probability of accessing to a candidate cell of the one or more candidate SNs; for example, the probability of accessing to a cell of C-SN1 is 70%.

The above items a) to f) may be statistical values for a past period of time, or predicted values for a future period of time, or real-time data. For example, the measurement results may be the RSRP of a cell of candidate SN1 for a past period of time, i.e. in the last 10 minutes; or the RSRP of the cell determined at present, or predicted RSRP of the cell within a future period of time, i.e., the RSRP from 17:00 to 17:10 predicted by the UE at 15:00.

The second information may include at least one of the following information in the one or more candidate nodes or in one or more candidate cells managed by the one or more candidate nodes, and the second information may include at least one of the following information in the S—SN:
a) the total number of active UEs;
b) resource utilization;
c) capacity, which may include the available capacity;
d) RRC connections;
e) transport network layer (TNL) capacity;
f) QoS, or traffic parameters of the one or more neighbor nodes, i.e., per QoS level latency, e.g., E2E latency, RTT, L2-latency, or the like; per QoS level packet loss rate, per QoS level jitter;
g) a cell load;
h) SN change frequency or PSCell change frequency;
i) a predicted probability of being accessed by the UE.

The above items a) to h) may be statistical information for a past period of time, or predicted information for a future period of time, or real-time data. For example, the number of active UEs may be the average number of active UEs in a past period of time, such as in the last 10 minutes, the average active UE in a cell of candidate SN1 is 200; or the number determined at present, for example, now there is 210 active UEs in the cell; or a predicted number within a future period of time, for instance, the predicted total number of the UE from 17:00 to 17:10 in the cell may be 300.

It should be noted that steps 401, 402, and 403 may be performed in any order. Further, other steps that are not depicted can be incorporated in these steps. For example, one or more additional steps can be performed before, after, simultaneously, or between any of the steps. In certain circumstances, one or more steps within step 401, 402, and 403 can be skipped. In certain circumstances, multitasking and parallel processing can be advantageous. In some other scenarios, the MN may only receive the first information or the second information. In some other scenarios, the MN may receive the first information and the second information.

In step 404, after receiving the first information and/or the second information, the MN performs inference, e.g. the MN performs a ML-based SN change action or a ML-based PSCell change action with the ML model. Based on the first information and/or the second information, the MN determines at least one of the following actions or parameters with the ML model:
a) whether to perform the SN change or the PSCell change. In other words, whether the MN sends the RRC message to the UE for the SN/PSCell change or not, and/or whether the MN performs SN addition preparation procedure with the target SN or not;
b) whether to perform an inter-SN PSCell change or an intra-SN PSCell change;
c) when to trigger the SN change or the PSCell change, e.g., when to send the RRC message to the UE for SN/PSCell change, and/or when the MN performs SN addition preparation procedure with the target SN;
d) which node is the target SN, or how to identify the target SN;
e) which cell is the target PSCell, or how to identify the target PSCell;
f) SN change parameters, e.g., SN change trigger threshold, time-to-trigger value;
g) PSCell change parameters, e.g., PSCell change trigger threshold, time-to-trigger value;
h) whether to activate or deactivate the target SCG associated with the target SN if SN change or the PSCell change is triggered.

If the MN decides to perform the inter-SN PSCell change procedure or the AI/ML-based SN change action, in step 404, the MN determines a target SN from the candidate SNs, which is C-SN1 in FIG. 4, and the MN performs a SN addition procedure with the target SN in step 405. In step 406, the MN transmits the SN change command to the UE. After receiving this command, in step 407, the UE performs a RACH procedure with the target SN, and synchronizes to the target SN.

If the MN decides to perform the intra-SN PSCell change procedure or the AI/ML-based intra-SN PSCell change action, in step 404, the MN determines the S—SN is the target SN, and step 405 does not exist, but the MN can update SCG configuration with the target SN (i.e. S—SN). In step 406, the MN transmits the intra-SN PSCell change command to the UE. After receiving this command, in step 407, the UE performs a RACH procedure with the target PSCell (i.e. cell in the S—SN), step 407 is performed optionally, sometimes it can be skipped.

In some embodiments, the UE and/or the target SN may transmit feedback information regarding the PSCell/SN change process to the MN after the UE successfully hand over to the target SN/PSCell automatically or based on MN's request.

In step 408, the UE may transmit the first feedback to the MN, optionally, the UE may transmit the first feedback to the target SN, and the target SN may forward the first feedback to the MN. The first feedback can be treated as reward information for ML model re-training/update. The first feedback includes at least one of the following information in the target SN or in the target PSCell:
a) a time period from a time point when the UE accessed to the target SN or the target PSCell to a time point when the UE is out of a coverage of the target SN or the target PSCell;
b) QoS or traffic parameters, for example, per QoS level latency, the latency may include: E2E latency, RTT, L2-latency, or the like; per QoS level packet loss rate, per QoS level jitter, these parameters may be instantaneous parameters, or average parameters;
c) one or more UE traffic patterns after the SN change or the PSCell change;
d) resource utilizations used by UE, e.g. the radio efficiency, which may be represented with bit per second per hertz;
e) one or more service requirements of the UE;
f) any change in UE service requirements;
g) one or more connectivity configurations of the UE after SN/PSCell change;
h) activation or deactivation frequency of the target SCG after SN/PSCell change

In step 409, the target SN may also transmit the second feedback to the MN, the second feedback can be treated as reward information for ML model re-training/update. The second feedback includes at least one of the following information in the target SN or in the target PSCell:
a) a time period from a time point when the UE accessed to the target SN or the target PSCell to a time point when the UE is out of a coverage of the target SN or the target PSCell;
b) QoS or traffic parameters, for example, per QoS level latency, the latency may include: E2E latency, RTT, L2-latency, or the like; per QoS level packet loss rate, per QoS level jitter, these parameters may be instantaneous parameters, or average parameters;
c) radio efficiency associated with the target SN or the target PSCell;
d) mobility history information associated with the target SN or the target PSCell; and
e) one or more connectivity configurations applied by the target SN or the target PSCell.
f) activation or deactivation frequency of the target SCG after SN/PSCell change

For inter-SN PSCell Change, the target SN is a node different from the source SN, for intra SN PSCell change, the target SN is the source SN.

It should be noted that the step 408 and step 409 may not take place in the order of step 408 first and step 409 second. Step 409 may precede step 408, or step 408 and step 409 happen at the same time. Further, other steps that are not depicted can be incorporated in these two steps. For example, one or more additional steps can be performed before, after, simultaneously, or between any of the steps. In certain circumstances, step 408 or 409 can be skipped. In certain circumstances, multitasking and parallel processing can be advantageous.

If the MN is capable to determine the ML model by itself, after receiving the first feedback from the UE, and/or the second feedback from the target SN, the MN may retrain the ML model. After the re-training, the MN may update the ML model with the newly trained ML model. In some embodiments, only when the newly trained ML model has a better performance than the current used ML model, the MN replaces the current ML model with the newly trained ML model.

If the MN is not capable to determine the ML model by itself, e.g. the MN achieves the ML model from the OAM or UE or other RAN node(s) or other locations, in step 410, the MN may transmit the first feedback, and/or the second feedback to a host (e.g. training host in FIG. 4) who provides the ML model to the MN. The MN may also send the determined actions (determined in step 404 with the ML model) to the training host. After receiving the feedback and/or the determined actions, in step 411, the training host may retrain the ML model. After the training, the training host may update the ML model with the newly trained ML model. In some embodiments, only when the newly trained ML model has a better performance than the current ML model, the training host then updates the ML model, or the MN replaces the current ML model with the newly trained ML mode.

If the MN is not capable to determine the ML model by itself, in step 412, the training host transmits the newly trained ML model to the MN, and in step 413, after receiving the updated ML model, the MN can remove the previous ML model and use the updated ML model for subsequent inference.

In some preferred embodiment, the MN may request the first information from the UE, and/or the second information from the candidate SN(s), and/or the second information from the S—SN. For example, before step 402, the MN may transmit a first request to the UE, which requests the first information, and before steps 403A-1, . . . , 403A-x, the MN may transmit a second request to each of the candidate SN(s) separately, which requests the second information, also before steps 403-B, the MN may transmit a second request to the S—SN to request the second information.

After receiving the first request, the UE transmits the first information to the MN in step 402; similarly, after receiving the second request, each of the candidate SNs transmits the second information to the MN separately in steps 403A-1, . . . 403A-x, also, the S—SN transmits the second information to the MN.

In other preferred embodiments, the MN may request the first feedback from the UE, and/or the second feedback from the target SN, which may be the source SN for intra-SN PSCell change, and may be a different SN rather than the source SN for inter-SN PSCell change. For example, before step 408, the MN may transmit a third request to the UE, which requests the first feedback, before step 409, the MN transmit a fourth request to the target SN, which requests the second feedback. In some embodiment, the MN may transmit a third request to the target SN, to request the first feedback of the UE, and then the target SN may transmit a sixth request to the UE, to request the first feedback of the UE.

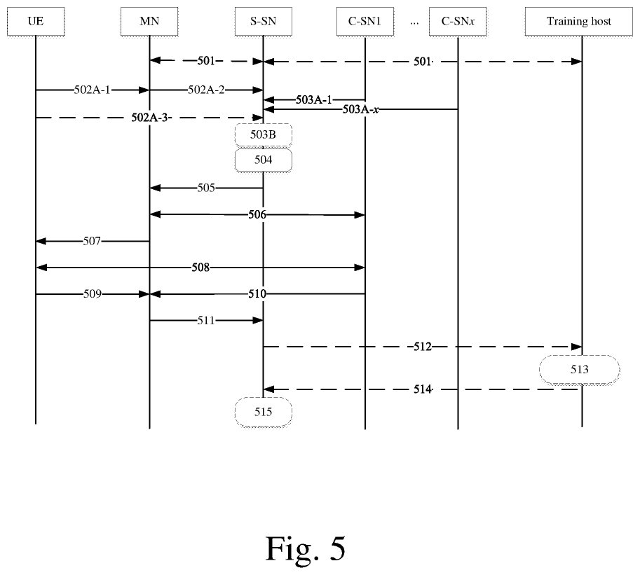

FIG. 5 illustrates a flow chart of SN change or PSCell change initiated by the SN using the ML technology according to some embodiments of the present disclosure.

FIG. 5 at least includes 6 components, the UE, the MN, the source SN (S—SN), the candidate SN1 (C-SN1), . . . , the candidate SNx (C-SNx), and the training host, wherein x is an integer equal to or larger than one. Each candidate SN may manage one or more cells, and the cell that is accessed by the UE is considered as the target PSCell of the UE, the target PSCell may be one cell managed by the source SN or one candidate SN.

In step 501, the source SN determines the ML model to be applied. If the source SN is capable of training the ML model, then the source SN may determine the ML model by itself or deploy the ML model trained by the source SN itself. If the source SN is not capable of training the ML model, it may obtain the ML model from other nodes. For example, the ML model may be received from a training host, such as the OAM or the MN or a UE or any source that can provide the ML model to the source SN.

In step 502A-1, the UE transmits the first information to the MN, and in step 502A-2, the MN forwards the first information to the source SN. Alternatively, in step 502A-3, the UE may transmit the first information directly to the source SN. Additionally, the MN can transmit the first information generated by the MN itself to the source SN.

In step 503A-1, . . . , step 503A-x, the candidate SN1, . . . , the candidate SNx transmits the second information to the source SN separately. In some other scenarios, when there is no interface between the source SN and the candidate SN, the candidate SN may transmit the second information to the MN, and then the MN may forward the second information of the candidate SN to the source SN. Also, the source SN can determine the second information by itself in step 503B, and the second information includes the information in the one or more cells managed by the source SN, the target PSCell after PSCell change can be one cell that managed by the source SN.

It should be noted that steps 501, 502, and 503 may be performed in any order. Further, other steps that are not depicted can be incorporated in these steps. For example, one or more additional steps can be performed before, after, simultaneously, or between any of the steps. In certain circumstances, one or more steps within step 501, 502, and 503 can be skipped. In certain circumstances, multitasking and parallel processing can be advantageous. In some other scenarios, the S—SN may only receive first information or the second information. In some other scenarios, the S—SN may receive the first information and the second information.

In step 504, after receiving the first information, which either is received from the UE directly, or forwarded by the MN; and/or the second information, which is also either received from each candidate SN directly or forwarded by the MN, the source SN performs inference, e.g. the S—SN performs a AI/ML-based SN change action or a AI/ML-based PSCell change action. The first information are similar to the first information as illustrated in the method of FIG. 4, and the second information are similar to the second information as illustrated in the method of FIG. 4. The first information and/or the second information can be treated as inference data for prediction or guidance, or determining at least one action.

In other words, the source SN determines at least one of the following actions or parameters with the ML model:
a) whether to perform the SN change or the PSCell change. In other words, whether the source SN sends the SN change required message to the MN or not;
b) whether to perform an inter-SN PSCell change or an intra-SN PSCell change;
c) when to trigger the SN change or the PSCell change, e.g., when to send the SN change required message to the MN for SN/PSCell change;
d) which node is the target SN, or how to identify the target SN;
e) which cell is the target PSCell, or how to identify the target PSCell;
f) SN change parameters, e.g., SN change trigger threshold, time-to-trigger value;
g) PSCell change parameters, e.g., PSCell change trigger threshold, time-to-trigger value;
h) whether to activate or deactivate the target secondary cell group associated with the target SN.

If the SN decides to perform the inter-SN PSCell change procedure or the AI/ML-based SN change action, in step 505, the SN transmits the SN Change Required message to the MN to indicate that it is inter-SN PSCell change. The step 506 to step 508 are similar to step 405 to step 407, and the details are omitted here.

If the SN decides to perform the intra-SN PSCell change procedure or the AI/ML-based intra-SN PSCell change action, in step 505, the SN transmits the SN Change Required message to the MN to indicate that it is intra-SN PSCell change. The step 506 does not exist, but the MN can update SCG configuration with the target SN (i.e. S—SN). In step 507, the MN transmits the intra-SN PSCell change command to the UE. After receiving this command, in step 508, the UE performs a RACH procedure with the target PSCell (i.e. cell in the S—SN), step 508 is performed optionally, sometimes it can be skipped.

In step 509, the UE may transmit the first feedback information to the MN, and the first feedback information is identical to the first feedback illustrated in FIG. 4, and the details are omitted here.

In step 510, the target SN may transmit the second feedback information to the MN, the second feedback information is identical to the second feedback illustrated in FIG. 4, and the details are omitted here.

It should be noted that the step 509 and step 510 may not take place in the order of step 509 first and step 510 second. Step 510 may precede step 509, or step 509 and step 510 happen at the same time.

After receiving the first feedback information and the second feedback information, in step 511, the MN transmits them to the source SN.

In FIG. 5, the source SN receives the first feedback and the second feedback via the MN's forwarding. There are other manners for the source SN to obtain the first feedback information and the second feedback information.

Regarding the first feedback information, the UE may also transmit the first feedback information to the target SN, and if there is an interface, such as the Xn interface between the target SN and the source SN, the target SN may transmit the first feedback information to the source SN. If there is no interface between the target SN and the source SN, the target SN may transmit the first feedback information to the MN, and then the MN transmits the first feedback information source SN. That is, the source SN may receive the first feedback information from the MN or from the target SN.

Regarding the second feedback information, if there is an interface, such as the Xn interface between the target SN and the source SN, the target SN may transmit the second feedback information to the source SN directly. If there is no interface between the target SN and the source SN, the target SN may transmit the second feedback information to the MN, and then the MN transmits the second feedback information source SN. In conclusion, the source SN may receive the second feedback information from the MN or from the target SN.

If the source SN is capable to determine the ML model by itself, after receiving the first feedback of the UE, and/or the second feedback of the target SN, the source SN may retrain the ML model. After the re-training, the source SN may update the ML model with the newly trained ML model. In some embodiments, only when the newly trained ML model has a better performance than the current used ML model, the source SN replaces the current ML model with the newly trained ML model.

If the source SN is not capable to determine the ML model by itself, e.g. the S—SN achieves the ML model from the OAM or UE or the MN or other RAN node(s) or other locations, in step 512, the source SN may transmit the first feedback and/or the second feedback to a host (e.g. training host in FIG. 5) who provides the ML model to the S—SN. The source SN may also send the determined actions to the training host (i.e. the actions determined in step 504). After receiving the feedback and/or the determined actions, in step 513, the training host may retrain the ML model. After the re-training, the training host may update the ML model with the newly trained ML model. In some embodiments, only when the newly trained ML model has a better performance than the current ML model, the training host then updates the ML model, or the source SN replaces the current ML model with the newly trained ML model.

If the source SN is not capable to determine the ML model by itself, in step 514, the training host transmits the newly trained ML model to the source SN, and in step 515, after receiving the updated ML model, the source SN can remove the previous ML model and use the updated ML model for subsequent inference.

In some preferred embodiment, the source SN may request the first information from the UE, and/or the first information from the MN, and/or the source SN may request the second information from the MN, and request the second information from the candidate SNs. For example, before step 502A the source SN may request the first information of the UE, or the source SN may request the first information from the MN. Before steps 503A-1, . . . , 503A-x, the source SN may request the second information of the candidate SNs. Assuming the first request requests for the first information, and the second request requests for the second information of one candidate SN, then the source SN may transmit the first request and the second request according to the following table 1:

TABLE 1

| | the first request is | the second request is |
|---|---|---|
| | transmitted to: | transmitted to: |
| 1 | the MN | the MN |
| 2 | the MN | one or more candidate SNs |
| 3 | the MN | the MN and the one or more candidate SNs |
| 4 | the UE | the MN |
| 5 | the UE | one or more candidate SNs |
| 6 | the UE | the MN and the one or more candidate SNs |
| 7 | the MN and the UE | the MN |
| 8 | the MN and the UE | one or more candidate SNs |
| 9 | the MN and the UE | the MN and the one or more candidate SNs |

According to table 1, in the 1^{st} row, the source SN transmits first request to the MN, and/or transmit a second request to the MN. In the 3^{rd} row, the source SN transmit the first request to the MN, and/or, transmit one second request to the MN and at least transmit another second request to one node within the one or more candidate SNs separately if there is an interface between the source SN and each candidate SN. In the 9th row, the source SN transmits one first request to the MN, and another first request to the UE, and/or, transmits one second request to the MN, and at least transmit another second request to one node within the one or more candidate SNs. It should be noted that the transmission between the source SN and the one or more candidate SNs requires an interface such as the Xn interface between the source SN and each candidate SN, when there is no interface between the source SN and the one or more candidate SNs, the transmission needs to be forwarded by the MN.

As can be seen, the first request and the second request may be transmitted in the same message, for example, in the 1^{st} row, since the first request and the second request are both transmitted to the MN, the source SN may use one message for the first request and the second request. The two requests may be transmitted in two or more different messages when the two requests are transmitted to different nodes, for example, in the 2^{nd} row, the S—SN may transmit one message to the MN for the first request, and/or at least transmit another message to one node within the one or more candidate SNs separately for the second request.

After receiving the first request and/or the second request, the MN, the candidate SN, or the UE shall transmit the corresponding information to the source SN. More specifically, regarding the above rows in table 1, the corresponding responses are as presented in the following table 2:

TABLE 2

| | the first information is | the second information is |
|---|---|---|
| | received/forwarded from: | received/forwarded from: |
| 1 | the MN | the MN |
| 2 | the MN | one or more candidate SNs |
| 3 | the MN | the MN and the one or more |
| | | candidate SNs |
| 4 | the UE | the MN |
| 5 | the UE | one or more candidate SNs |
| 6 | the UE | the MN and the one or more |
| | | candidate SNs |
| 7 | the MN and the UE | the MN |
| 8 | the MN and the UE | one or more candidate SNs |
| 9 | the MN and the UE | the MN and the one or more |
| | | candidate SNs |

According to table 2, in the 1^{st} row, the MN forwards the first information and/or the second information to the source SN; in the 3^{r} row, the MN forwards the first information to the source SN, and/or the MN forwards the second information to the source SN, and the one or more candidate SNs transmit the second information to the source SN. In the 9^{th} row, the UE transmits the first information to the source SN, and the MN also forwards the first information to the source SN; and/or, the MN forwards the second information to the source SN, and the one or more candidate SNs also transmit the second information to the source SN. It should be noted that the transmission between the source SN and each candidate SN requires an interface such as the Xn interface between the source SN and each candidate SN, when there is no interface between the source SN and each candidate SN, the transmission needs to be forwarded by the MN.

In other preferred embodiments, the source SN may at least transmit a third request to the MN and/or to the target SN, for the first feedback from the UE, and/or, transmit a fourth request to the MN and/or to the target SN, for the second feedback from the target SN. For example, before step 509 and step 510, the source SN may transmit the third request and the fourth request according to the following table 3:

TABLE 3

| | the third request is | the fourth request is |
|---|---|---|
| | transmitted to: | transmitted to: |
| 1 | the MN | the MN |
| 2 | the MN | the target SN |
| 3 | the MN | the MN and the target SN |
| 4 | the target SN | the MN |
| 5 | the target SN | the target SN |
| 6 | the target SN | the MN and the target SN |
| 7 | the MN and the target SN | the MN |
| 8 | the MN and the target SN | the target SN |
| 9 | the MN and the target SN | the MN and the target SN |

According to table 3, in the 1^{st} row, the source SN transmits the third request to the MN, and/or transmits the fourth request to the MN. In the 3^{rd} row, the source SN transmits the third request to the MN, and/or, transmits one fourth request to the MN and another fourth request to the target SN. In the 9^{th} row, the source SN transmits one third request to the MN, and another third request to the target SN, and/or, transmits one fourth request to the MN and another fourth request to the target SN. It should be noted that the transmission between the source SN and the target SN requires an interface such as the Xn interface between the two SNs, when there is no interface between the source SN and the target SN, the transmission between the two SNs needs to be forwarded by the MN.

Correspondingly, after receiving the third request and/or the fourth request, the MN and/or the target SN may transmit the third feedback and/or the fourth feedback to the source SN. More specifically, regarding the above rows in table 3, the corresponding responses are as presented in the following table 4:

TABLE 4

| | the first feedback is | the second feedback is |
|---|---|---|
| | received/forwarded from: | received/forwarded from: |
| 1 | the MN | the MN |
| 2 | the MN | the target SN |
| 3 | the MN | the MN and the target SN |
| 4 | the target SN | the MN |
| 5 | the target SN | the target SN |
| 6 | the target SN | the MN and the target SN |
| 7 | the MN and the target SN | the MN |
| 8 | the MN and the target SN | the target SN |
| 9 | the MN and the target SN | the MN and the target SN |

According to table 4, in the 1^{st} row, the MN forwards the first feedback and/or the second feedback to the source SN; in the 3^{rd} row, the MN forwards the first feedback to the source SN, and/or the MN forwards the second feedback to the source SN, and/or the target SN transmit the second feedback to the source SN. In the 9^{th} row, the MN forwards the first feedback to the source SN, and the target SN forwards the first feedback to the source SN; and/or, the MN forwards the second feedback to the source SN, and the target SN transmit the second feedback to the source SN. It should be noted that the transmission between the source SN and the target SN requires an interface such as the Xn interface between the two SNs, when there is no interface between the source SN and the target SN, the transmission between the two SNs needs to be forwarded by the MN.

As can be seen, the third request and the fourth request may be transmitted in the same message when the two requests are both transmitted to the same node (e.g. the same node can be the MN or the target SN). The two requests may be transmitted in two or more different messages when the two requests are transmitted to different nodes.

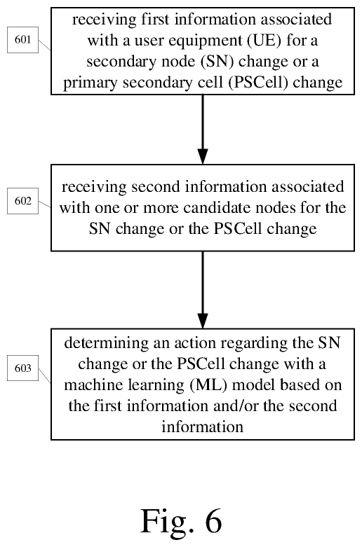

FIG. 6 illustrates a method performed by a node for performing a SN change procedure according to a preferred embodiment of the present disclosure.

In step 601, the node, such as the MN, or the S—SN, receives first information associated with a user equipment (UE) for a secondary node (SN) change or a primary secondary cell (PSCell) change; in step 602, the node receives second information associated with one or more candidate nodes for the SN change or the PSCell change; and in step 603, the node determines an action regarding the SN change or the PSCell change with a ML model based on the first information and/or the second information.

For example, in step 402, step 403A-1, . . . , 403A-x, step 403B, the MN receives the first information and the second information, and in step 404, the MN determines an action with the AI or ML model based SN or PSCell change action, policy, or guidance.

After determining the action, the node may trigger the SN change or the PSCell change. For example, if the determined action is to perform a SN change, then the node triggers the SN change procedure with the UE and the target SN.

In some embodiments, the first information is received from the UE directly and/or from a MN. In some embodiments, the second information is received from the one or more candidate SNs and/or from the MN and/or from the source SN, or is determined by a source SN itself.

In some embodiments, the node, i.e. the MN or the source SN (i.e. S—SN), may also receive a first feedback from the UE directly or indirectly. In some embodiments, the node may receive the second feedback from the target SN and/or from a master node, and/or determining the second feedback. For example, when the node is the MN, the MN may receive the first feedback of the UE from the UE, and/or the MN may receive the first feedback of the UE from the target SN since the target SN receives the first feedback of the UE from the UE, the MN may receive the second feedback from the target SN. For example, when the node is the S—SN, the S—SN may receive the first feedback of the UE from the MN since the MN receives the first feedback of the UE from the UE, and/or, the MN receives the first feedback of the UE from the target SN (if the UE transmits the first feedback of the UE to the target SN); and/or, the S—SN may receive the first feedback of the UE from the target SN since the target SN receives the first feedback of the UE from the UE; and/or, the S—SN may receive the second feedback from the target SN; and/or, the S—SN may receive the second feedback from the MN since the MN receives the second feedback from the target SN; and/or, the S—SN may determine the second feedback by itself.

After receiving the first feedback and/or the second feedback, if the node is capable of retraining the ML model, the node may retrain the ML model based on the first feedback and/or the second feedback and/or a determined action; and update the ML model when retraining is finished.

If the node is not capable of retraining the ML model, the node may transmit the first feedback, the second feedback, and the determined action, to a host (e.g. training host) which provides the ML model to the node, for retraining the ML model. The node may receive an updated ML model from the training host.

In some embodiments, the node may transmit a first request to a master node and/or to the UE for the first information; and/or, transmit a second request to a master node and/or to the one or more candidate nodes for the second information. For example, the source SN in FIG. 4B may transmit the first request to the MN and/or to the UE for the first information, and/or, transmit the second request to the MN and/or to the one or more candidate SNs for the second information. The one or more candidate SNs may be determined based on the first information of the UE. For example, the candidate SNs may include a SN located in an area the UE is heading, and the area is determined based on the velocity and the direction of the UE included in the first information. The first request and the second request may be transmitted in one message or transmitted in two different messages. For example, the source SN may transmit one message including the first request and the second request to the MN, or transmit one message including the first request to the UE, and transmit another message including the second request to the MN.

In some embodiments, the node may at least transmit a third request to the UE, or a master node (MN), or a target SN, for the first feedback; and/or at least transmit a fourth request to the MN or the target SN for the second feedback. For instance, the source SN may transmit the third request to the MN, and transmit the fourth request to the MN, too. For another instance, the source SN may transmit the third request to both the MN and the target SN, because the source SN is not sure which node, the MN, or the target SN, has the first feedback of the UE. The third request and the fourth request may be transmitted in one message or transmitted in two different messages. For example, the source SN may transmit one message including the third request and the fourth request to the MN, or transmit one message including the third request to the MN, and transmit another message including the fourth request to the target SN.

In some embodiment, the node may transmit a fifth request for the ML model to a host which trains the ML model for SN change or PSCell change. For instance, in step 501 in FIG. 5, the S—SN may transmit a request for the ML model to the training host.

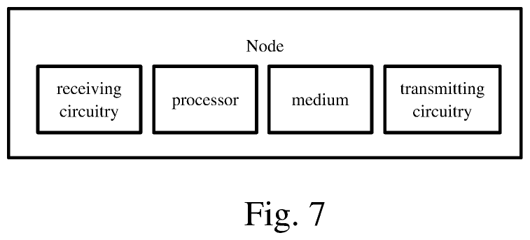

FIG. 7 illustrates a block diagram of a node according to some embodiments of the present disclosure.

The node may include a receiving circuitry, a processor, and a transmitting circuitry. In one embodiment, the node may include at least one non-transitory computer-readable medium having computer executable instructions stored therein. The processor can be coupled to the at least one non-transitory computer-readable medium, the receiving circuitry and the transmitting circuitry. The computer executable instructions can be programmed to implement a method with the receiving circuitry, the transmitting circuitry and the processor.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the FIGS. may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method of performing a network function, the method comprising:
receiving first information associated with a user equipment (UE) for a secondary node (SN) change or a primary secondary cell (PSCell) change; and/or
receiving second information associated with one or more candidate nodes for the SN change or the PSCell change; and
determining an action regarding the SN change or the PSCell change with a machine learning (IL) model based on the first information and/or the second information.

2. The method of claim 1, further comprising:
triggering the SN change or the PSCell change based on a determined action.

3. The method of claim 1, wherein the first information is received from the UE directly and/or from a master node, and includes at least one of the following information:
one or more measurement results of one or more candidate cells managed by the one or more candidate nodes;
mobility history information;
predicted quality of service (QoS), or traffic parameters of the one or more candidate nodes;
QoS or traffic parameters of the one or more candidate nodes in a past time period;
a predicted cell load of each of the one or more candidate cells;
a cell load of each of the one or more candidate cells in a past time period;
a predicted SN change frequency or a predicted PSCell change frequency;
a SN change frequency or a PSCell change frequency in a past time period; and
a predicted probability of accessing to the one or more candidate cells.

4. The method of claim 1, wherein the second information is received from the one or more candidate nodes and/or from a master node and/or from a source SN, or determined by a source secondary node, and
wherein the second information includes at least one of the following information in the one or more candidate nodes or in one or more candidate cells managed by the one or more candidate nodes:
a number of active UEs in a past time period;
resource utilization in the past time period;
a capacity in the past time period-;
QoS or traffic parameters in the past time period;
RRC connections in the past time period;
a cell load in the past time period;
SN change frequency in the past time period;
a predicted number of active UEs;
predicted resource utilization;
a predicted capacity;
predicted QoS or predicted traffic parameters;
predicted RRC connections;
a predicted cell load;
predicted SN change frequency; and
a predicted probability of being accessed by the UE.

5. The method of claim 1, wherein the action includes at least one of the following information:
a determination for whether performing a SN change or a PSCell change or not;
a determination of a time for performing the SN change or the PSCell change;
a determination for performing an inter-SN PSCell change or an intra-SN PSCell change;
a determination of a target node for the SN change;
a determination of a target PSCell for the PSCell change;
a determination of SN change or inter-SN PSCell change parameters;
a determination of PSCell change or intra-SN PSCell change parameters; and
a determination for activating or deactivating a target secondary cell group corresponding to a target SN.

6. The method of claim 1, further comprising:
receiving a first feedback from the UE directly or indirectly, wherein the first feedback includes at least one of the following information:
a time period from a time point when the U E accessed to a target SN or a target PSCell to a time point when the UE is out of a coverage of the target SN or the target PSCell;
QoS level latency, a QoS level packet loss rate, or a QoS level jitter in the target SN or a target PSCell;
one or more traffic patterns of the UE in the target SN or the target PSCell;
resource utilization of the UE in the target SN or the target PSCell;
one or more service requirements of the UE; and
one or more connectivity configurations of the UE.

7. The method of claim 1, further comprising:
receiving a second feedback from a target SN and/or from a master node, or determining the second feedback, wherein the second feedback includes at least one of the following information:
a time period from a time point when the UE accessed to the target SN or a target PSCell to a time point that when UE is out of a coverage of the target SN or the target PSCell;
QoS level latency, a QoS level packet loss rate, or a QoS level jitter associated with the target SN or the target PSCell;
radio efficiency associated with the target SN or the target PSCell;
mobility history information associated with the target SN or the target PSCell; and
one or more connectivity configurations applied by the target SN or the target PSCell.

8. The method of claim 6, further comprising:
retraining the ML model based on the first feedback and/or a determined action; and
updating the ML model.

9. The method of claim 6, further comprising:
at least transmitting the first feedback, or a determined action, to a host which provides the ML model, for retraining the ML model.

10. The method of claim 9, further comprising:
receiving an updated ML model.

11. The method of claim 1, further comprising:
at least transmitting a first request to a master node or to the UE for the first information; and/or
at least transmitting a second request to a master node or to the one or more candidate nodes for the second information.

12. The method of claim 11, wherein the one or more candidate nodes are determined based on the first information.

13. The method of claim 11, wherein the first request and the second request are transmitted in one message or transmitted in two different messages.

14. The method of claim 1, further comprising:
at least transmitting a third request to the UE, or a master node (MN), or a target SN, for a first feedback; and/or
at least transmitting a fourth request to the MN or the target SN for a second feedback.

15. The method of claim 14, wherein the third request and the fourth request are transmitted in one message or transmitted in two different messages.

16. The method of claim 1, further comprising:
transmitting a fifth request for the ML model to a host which trains the ML model for SN change or PSCell change.

17. The method of claim 1, further comprising:
applying the ML model associated with the SN change or the PSCell change of the UE.

18. (canceled)

19. An apparatus for performing a network function, the apparatus comprising:
at least one memory; and
at least one processor coupled with the at least one memory and configured to cause the apparatus to:
receive first information associated with a user equipment (UE) for a secondary node (SN) change or a primary secondary cell (PSCell) change; and/or
receive second information associated with one or more candidate nodes for the SN change or the PSCell change; and
determine an action regarding the SN change or the PSCell change with a machine learning (ML) model based on the first information and/or the second information.

20. The apparatus of claim 19, further comprising:
triggering the SN change or the PSCell change based on a determined action.

21. The apparatus of claim 19, wherein the first information is received from the UE directly and/or from a master node, and includes at least one of the following information:
one or more measurement results of one or more candidate cells managed by the one or more candidate nodes;
mobility history information;
predicted quality of service (QoS), or traffic parameters of the one or more candidate nodes;
QoS or traffic parameters of the one or more candidate nodes in a past time period;
a predicted cell load of each of the one or more candidate cells;
a cell load of each of the one or more candidate cells in a past time period;
a predicted SN change frequency or a predicted PSCell change frequency;
a SN change frequency or a PSCell change frequency in a past time period; and
a predicted probability of accessing to the one or more candidate cells.
